(19) United States
(12) Patent Application Publication
(10) Pub. No.: US 2017/0206212 A1
(43) Pub. Date: Jul. 20, 2017

(54) PARTIAL SNAPSHOT CREATION

(71) Applicant: HEWLETT PACKARD ENTERPRISE DEVELOPMENT LP, Houston, TX (US)

(72) Inventors: Sandya Srivilliputtur Mannarswamy, Banglore (IN); Anand Satish Phatak, Bangalore (IN)

(21) Appl. No.: 15/325,015

(22) PCT Filed: Oct. 13, 2014
(86) PCT No.: PCT/US2014/060284

§ 371 Date: Jan. 9, 2017

(30) Foreign Application Priority Data
Jul. 17, 2014 (IN) 3522/CHE/2014

(51) Int. Cl. G06F 17/30; G06F 3/06

(52) U.S. Cl. CPC G06F 17/30088; G06F 17/30106; G06F 17/30171; G06F 17/3015; G06F 3/0604; G06F 3/064; G06F 3/065; G06F 3/067

(57) ABSTRACT

Partial snapshot creation includes identifying a file having requested data for providing to a user device in response to a user request. The file is stored in a plurality of physical data blocks of a storage device. A logical offset range corresponding to the requested data is ascertained. The logical offset range corresponds to a virtual location of the requested data in a file system. Range of physical data blocks in which the requested data is stored is determined based on a mapping table and a file parameter. The mapping table includes a mapping between the logical offset range and the requested data. A data block mapping between a snapshot inode, having metadata associated with partial snapshot, and the range of physical data blocks is created for obtaining a partial snapshot of the requested data. The partial snapshot is rendered to the user device in response to the user request.

### BACKGROUND

Increasing use of data processing and data generation in enterprises produces ever-increasing amounts of information which are stored for short, medium, or long periods. The information is typically stored for re-use by the organization. To maintain such information, such as data logs and files, enterprises generally implement data management and file storage systems for managing such information. Such systems further facilitate in sharing the stored information between various applications hosted, or used by the enterprise and its users. Generally, the stored information is shared such that an original copy of the information is not affected. For example, upon receiving a request for accessing certain data from a user, the systems may share a copy of the data instead of sharing original documents containing the data in order to prevent any modification by the user.

### BRIEF DESCRIPTION OF FIGURES

The detailed description is described with reference to the accompanying figures. In the figures, the left-most digit(s) of a reference number identifies the figure in which the reference number first appears. The same numbers are used throughout the figures to reference like features and components. Systems and/or methods, in accordance with examples of the present subject matter are now described, by way of example, and with reference to the accompanying figures, in which:

FIG. 1(a) illustrates a block diagram of an example system for partial snapshot creation, in accordance with an example of the present subject matter.

FIG. 1(b) illustrates various example components of the example system for partial snapshot creation, in accordance with an example of the present subject matter.

FIG. 2 illustrates an example method for partial snapshot creation, in accordance with an example of the present subject matter.

FIG. 3 illustrates another example method for partial snapshot creation, in accordance with an example of the present subject matter.

FIG. 4 illustrates an example network environment implementing a non-transitory computer readable medium for partial snapshot creation, according to an example of the present subject matter.

### DETAILED DESCRIPTION

Systems and methods for partial snapshot creation are described herein. The methods can be implemented in various systems, such as computing devices connected through various networks. Although the description herein is with reference to systems used for partial snapshot creation for multi-user file sharing, the methods and described techniques may be implemented in other systems, albeit with a few variations.

Typically, data is stored in a storage device through a file system. A file system may be understood as an abstraction for organizing and storing data on the storage device. The file system may also facilitate in controlling how the data is stored and retrieved from the storage device. A storage device includes many data storage units known as “blocks”. When a file is stored in the storage device, the file data is written and stored over multiple blocks. Therefore, each file is usually considered to be associated with a list of blocks storing the file data. A list of the blocks associated with the file is maintained and stored in an index node (inode) associated with the file. The inode includes metadata associated with the file. The metadata may include, inode number, attributes, number of blocks, file size, file type, block map information, and the like. The inode does not store the file data.

While storing, the file data in each file is allocated virtual addresses, also known as logical offsets that correspond to a virtual location of the data in a file system. For instance, considering a file to be a stream of bytes, a first byte of the stream will have a logical offset zero, a second byte will have a logical offset two, a third byte will have a logical offset three, and so on till the n^{th} byte that will have a logical offset n.

When the data is accessed by different applications, for example, by analytical and data presentation applications, a copy of the file containing the data accessed is created and written to new blocks, in addition to the blocks which may be retaining the actual data. For instance, depending on one or more queries requesting access to data, or portion thereof, data stored in the files may be processed and subsequently rendered on a user device in multiple formats based on a query executed on the data by the analytics or data presentation applications. To this end, portion of the data may be copies and stored in other blocks, and processed. Upon processing, the output data may be provided to the requesting user in a different form or format. However, it should be noted that as a result of the processing initiated by the executing queries, the original data is not updated. However, these applications typically create new files by fully copying data based on the presentation changes needed in the layout. Such a process of creating new file and writing the file to new blocks may result in unwanted duplication of data, leading to wastage of storage space. This, in turn may result in increase in storage costs as the enterprise may need to deploy additional storage devices for the files. Creation of the new file and writing the new file to the new blocks may further increase processing time of the applications.

The present subject matter, describes a system and a method for partial snapshot creation. The system and the method facilitate in creating a partial snapshot for rendering data to a user in response to a user request received from the user. The user request may be, for example, a query, such as a search query and an analytical query. Based on the user request, relevant requested data may be identified from a storage device associated with the system for creating the partial snapshot. The partial snapshot creation facilitates in rendering the requested data without creating a new data file having a copy of the requested data, thus preventing data duplication, in turn providing memory space utilization.

In accordance to an example of the present subject matter, upon receiving the user request, requested data, i.e., data that has to be provided to the user device in response to the user request is identified. Subsequently, a file having the requested data is identified from amongst a plurality of files stored in the storage device. In one example, the file may be stored in a plurality of physical data blocks of the storage device of the system. Once the file has been identified, the file and file data may be obtained and copied to a main memory, for example, random access memory of the system. The file may be subsequently analyzed to ascertain a logical offset range corresponding to the requested data. The logical offset range corresponds to a virtual location of the requested data in a file system. As previously described, a file system is used for organizing data on the storage device.

Further, from among the plurality of physical data blocks in which the file data of the file is stored, a range of physical data blocks in which the requested data is stored, is determined. In one example, the range of physical data blocks is determined based on a mapping table and a file parameter. Examples of the file parameter include, but are not limited to, a file inode and a file name corresponding to the file in which the requested data is stored. The mapping table includes a mapping between the logical offset range and the requested data. Upon determining the range of physical data blocks in which the requested data is stored, a data block mapping between a snapshot inode and the range of physical data blocks is created for obtaining a partial snapshot of the requested data. The snapshot inode includes metadata associated with the partial snapshot. Subsequently, the partial snapshot of the requested data is generated based on the snapshot inode and the data block mapping. As will be understood, the partial snapshot includes the requested data. The partial snapshot is subsequently rendered to the user device in response to the user request.

The present subject matter thus facilitates in creating partial snapshots for providing requested data to a user device. As will be understood based on the above description, the partial snapshot is created such that the snapshot inode is linked to the existing physical data blocks having the requested data. Linking the snapshot inode to the existing physical data blocks instead of copying the requested data to new physical data blocks facilitates in avoiding data duplication. Avoiding data duplication further facilitates in memory space utilization as memory space wastage due to the data duplication is avoided. Linking new inode, i.e., the snapshot inode to the existing physical data blocks instead of copying the requested data to new physical data blocks and then linking the snapshot inode to the new physical data blocks reduces processing time of the applications. The applications can now perform analytical and search functionalities faster as compared to known technologies. Further, the subject matter facilitates in creation of dynamic partial snapshots as the partial snapshots are created based on the user request. Since the partial snapshots are created based on the user request, a different snapshot may be created in response to each user request.

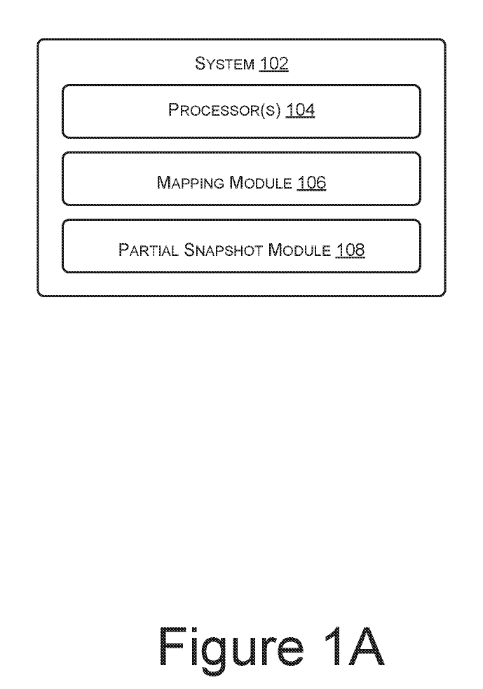

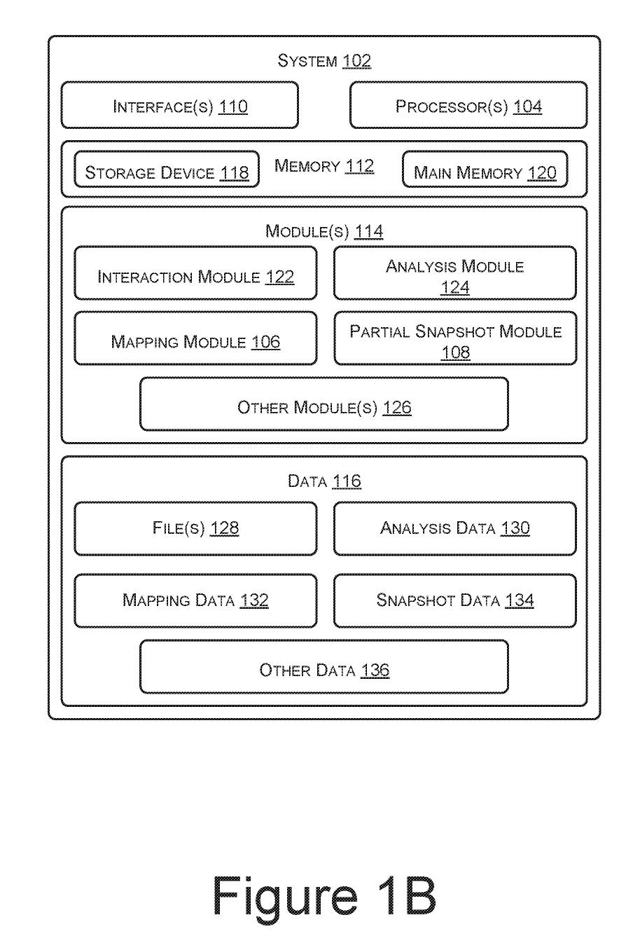

The above systems and methods are further described in conjunction with FIG. 1 to FIG. 4. It should be noted that the description and figures merely illustrate the principles of the present subject matter. It will thus be appreciated that various arrangements that embody the principles of the present subject matter, although not explicitly described or shown herein, can be devised from the description and are included within its scope. Furthermore, all examples recited herein are for pedagogical purposes to aid the reader in understanding the principles of the present subject matter. Moreover, all statements herein reciting principles, aspects, and examples of the present subject matter, as well as specific examples thereof, are intended to encompass equivalents thereof.

FIG. 1(a) illustrates a block diagram of an example system 102 for partial snapshot creation, in accordance with an example of the present subject matter. The system 102 may be implemented in, for example, desktop computers, multiprocessor systems, personal digital assistants (PDAs), laptops, network computers, cloud servers, minicomputers, mainframe computers, hand-held devices, such as tablets. The system 102 may also be hosting a plurality of applications.

The system 102 may include, for example, processor(s) 104, a mapping module 106 communicatively coupled to the processor 104, and a partial snapshot module 108 communicatively coupled to the processor 104.

The processor(s) 104 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions.

In operation, upon receiving a user request from a user, through a user device of the user, the user request is processed by the system 102. The user request may be processed to determine a file having requested data that has to be shared with the user device in response to the user request. The file may be identified from amongst a plurality of files stored in a storage device (not shown in the figure) associated with the system 100. The mapping module 106 subsequently ascertains a logical offset range corresponding to the requested data that has to be shared with the user device in response to the user request. The logical offset range corresponds to a virtual location of the requested data in a file system used for organizing information on the storage device.

The partial snapshot module 108 may subsequently use the logical offset range to determine a range of physical data blocks, from among a plurality of physical data blocks, in which the requested data is stored. The plurality of physical data blocks are the physical data blocks in which file data of the file is stored. In one example, the partial snapshot module 108 may determine the range of physical data blocks based on a mapping table and a file parameter. The mapping table, in one example, includes a mapping between the logical offset range and the requested data. Examples of the file parameter include, but are not limited to, as a file inode and a file name corresponding to the file in which the requested data is stored.

Further, the partial snapshot module 108 may create a data block mapping between a snapshot inode and the range of physical data blocks for obtaining a partial snapshot of the requested data. The snapshot inode includes metadata associated with the partial snapshot. The partial snapshot of the requested data thus created may be rendered to the user device.

FIG. 1(b) illustrates various example components of the system 102, in accordance with an example of the present subject matter. The system 102 includes the processor(s) 104, interface(s) 110, memory 112, modules 114, and data 116. The interfaces 110 may include a variety of commercially available interfaces, for example, interfaces for peripheral device(s), such as data input output devices, referred to as I/O devices, interface cards, storage devices, and network devices.

The memory 112 may be communicatively coupled to the processor 102 and may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In one example, the memory 112 may include a storage device 118 and main memory 120. The storage device 118, such as hard disks and magnetic tapes may be used for storing content, such as files in the system 102. The main memory 120, such as RAM may be used for temporary storage of content for processing by the system 102.

The modules 114, amongst other things, include routines, programs, objects, components, and data structures, which perform particular tasks or implement particular abstract data types. The modules 114 may also be implemented as, signal processor(s), state machine(s), logic circuitries, and/or any other device or component that manipulate signals based on operational instructions. Further, the modules 114 can be implemented by hardware, by computer-readable instructions executed by a processing unit, or by a combination thereof.

The modules 114 may include an interaction module 122, an analysis module 124, the mapping module 106, the partial snapshot module 108, and other module(s) 126. The other modules 126 may include programs or coded instructions that supplement applications and functions, for example, programs in an operating system of the system 102. Further, the data 116 may include file(s) 128, analysis data 130, mapping data 132, snapshot data 134, and other data 136.

As previously described, the system 102 facilitates in providing partial snapshots of data to a user device in response to a user request received from the user device. The user request may be a query by a user intending to search for certain data. For instance, a user working on an analytical or research related project may wish to search for certain data, from among the vast data stored in the memory 114. The user in such a case may provide the user request to the system 102. For example, a user intending to analyze literacy rate of countries having names starting with the alphabet ‘s’ may send a user request to the system 102 for providing data related to the literacy rate of such countries.

In one example, the user request is received by the interaction module 122. The interaction module 122 may save the user request in the analysis data 130. The user request is subsequently analyzed by the analysis module 124. The analysis module 124 may analyze the user request to determine requested data, i.e., the data that has to be shared with the user device. Upon determining the requested data that has to be shared, the analysis module 124 may perform a search to identify a file having the requested data. In one example, the file may be stored in a plurality of physical data blocks of the storage device 118. For instance, in the above described example of the analysis of the literacy rate, the analysis module 124 may analyze the user request to ascertain that user request is for requested data related to literacy rate of the countries having names starting with the alphabet ‘s’. The analysis module 124 may thus perform a search for identifying the file, from among the files 128, having requested data about the literacy rate of the countries across the world.

Upon identifying the file having the requested data, the analysis module 124 obtains the file for further analysis. In one example, the analysis module 124 copies the file and its file data into the main memory 120 from the storage device 118. In one example, the entire file maybe copied at once in the main memory 120. In another example, in case of large file size, parts of the file may be copied sequentially. The file may be subsequently analyzed by the mapping module 106 to determine the logical offset, i.e., the virtual location of the requested data in the file. As will be understood, the file will include the literacy rate for almost all the countries with the literacy rate being arranged, for example, in an alphabetical order of the names of the countries. The virtual location of the requested data in such a case may be the place in the file where the countries with their name starting from the alphabet ‘s’ are listed.

The mapping module 106 in such a case may subsequently ascertain the logical offset range based on the virtual location of the requested data. For instance, considering the file having the requested data to be a stream of bytes and the requested data is stored at the virtual locations 25-60 bytes. The requested data in such a case will have a logical offset range of 25-60. The mapping module 106 may further generate the mapping table based on the logical offset range of the requested data. In one example, the mapping table may include a beginning position of the logical offset range and a bit length corresponding to the logical offset range. The beginning position of the logical offset range may be the virtual location at which the requested data begins, for instance, the offset 25 in the above example. The bit length of the logical offset range may be difference between the beginning position and a last position of the logical offset range, for instance, bit length will be 35 in the above example. The mapping module 106 may subsequently save the mapping table in the mapping data 132. The mapping module 132 may further save the file parameter in the mapping module 132.

In one example, the partial snapshot module 108 may obtain the mapping table and the file parameter from the mapping data 132 to determine the range of physical data blocks of the storage device 118 in which the requested data is stored. As previously described, the range of physical data blocks is determined from among the plurality of physical data blocks in which the file is stored in the storage device 118. For instance, if the storage device includes physical data blocks numbered one to ten lakhs, the file may be stored in the plurality of physical data blocks numbered from, say, 100 to 150. Further, the range of physical data blocks having the requested data that has to be shared with the user may be numbered, say, 130 to 135. The partial snapshot module 108 may thus determine physical data blocks 130 to 135 as the range of physical data blocks corresponding to the requested data that has to be shared.

Subsequently, the partial snapshot module 108 may create a snapshot inode for obtaining the partial snapshot of the requested data. The snapshot inode includes metadata about the partial snapshot being created for the requested data. The metadata may include inode number, attributes, number of blocks, file size, file type, and the like. The partial snapshot module 108 may then create a data block mapping between the snapshot inode and the physical data blocks. The data block mapping may define a linking between the snapshot inode and the physical data blocks. The partial snapshot module 108 may subsequently generate the partial snapshot based on the snapshot inode and the data block mapping for being rendered to the user device. Further, the partial snapshot module 108 may save the partial snapshot in the snapshot data 134. Although the present subject matter has been described in the context of physical disk blocks, the present subject may be implemented for file systems which allocate data storage in terms of disk extents, i.e., a set of contiguous physical disk blocks.

In one example, the interaction module 122 renders the partial snapshot to the user device as a response to the user request received from the user device. For instance, in the above described example of the user request for obtaining the literacy rate of the countries having names starting with the alphabet ‘s’, the partial snapshot module 108 may generate a partial snapshot for literacy rate of the countries having names starting with the alphabet ‘s’. In said example, the snapshot inode may refer to the physical data blocks storing the requested data about literacy rate of the countries having names starting with the alphabet ‘s’. The interaction module 122 may subsequently render the partial snapshot of the literacy rates to the user device. Further, since the partial snapshots are created based on the user request, a different snapshot may be created in response to each user request. The partial snapshot module 108 may thus facilitate in providing dynamic partial snapshots.

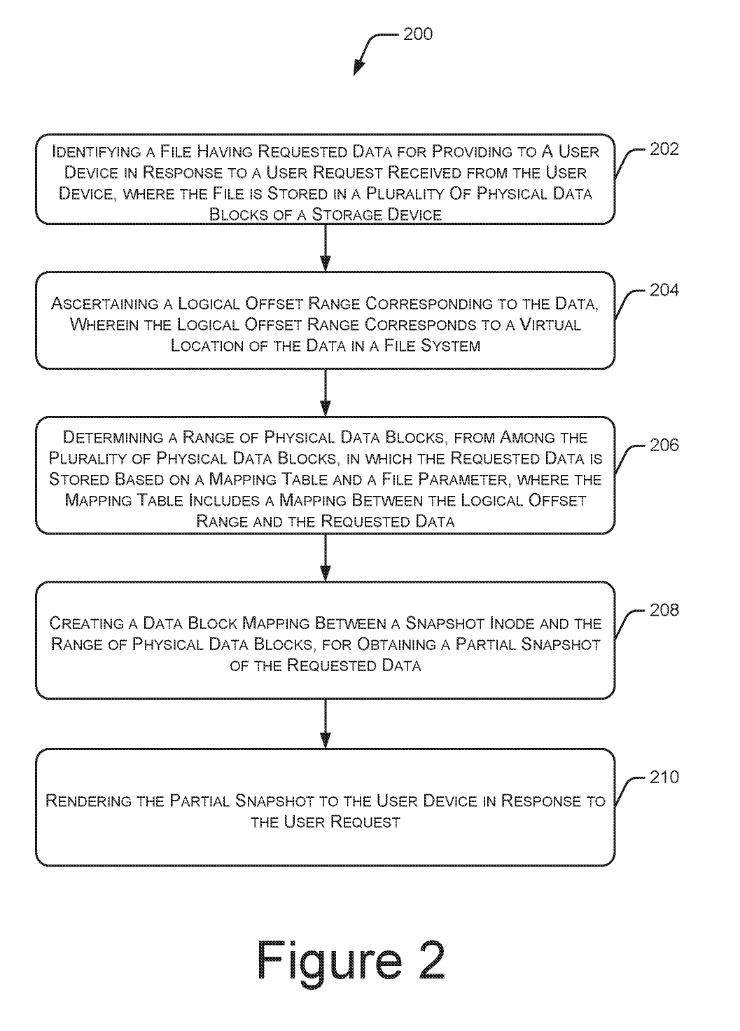

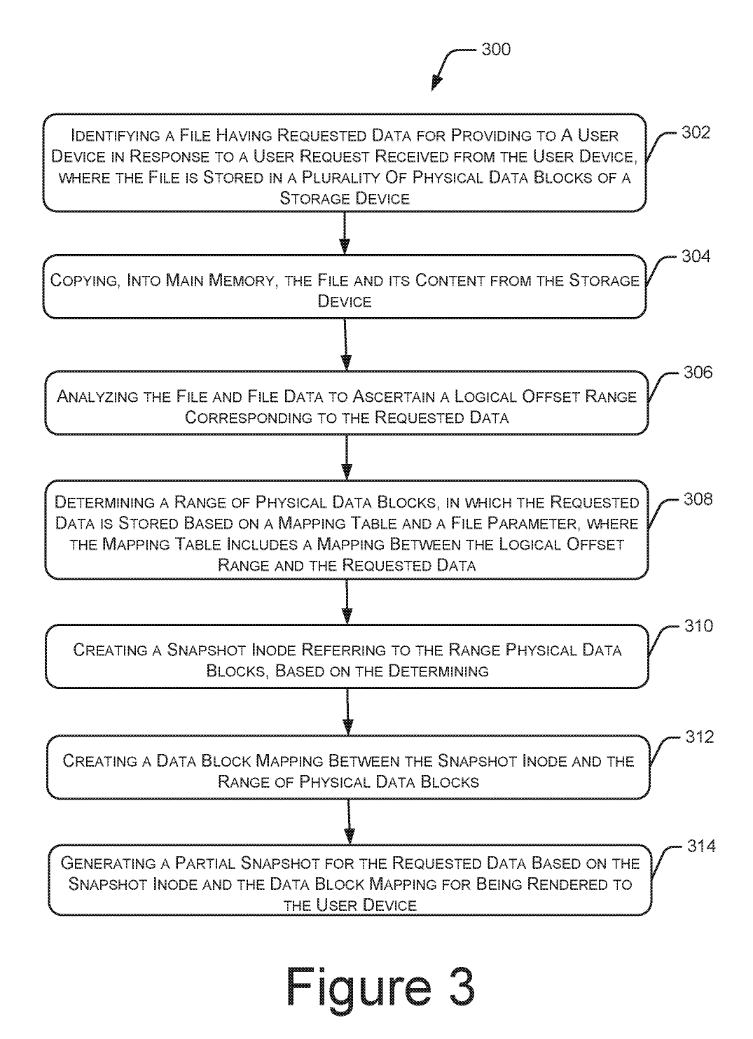

FIGS. 2 and 3 illustrate example methods 200 and 300, respectively, for partial snapshot creation, according to an implementation of the present subject matter. The order in which the methods are described is not intended to be construed as a limitation, and any number of the described method blocks may be combined in any order to implement the aforementioned methods, or an alternative method. Furthermore, the methods 200 and 300 may be implemented by processing resource or computing device(s) through any suitable hardware, non-transitory machine readable instructions, or combination thereof.

It may also be understood that the methods 200 and 300 may be performed by programmed computing devices, such as the system 102 as depicted in FIGS. 1A and 1B. Furthermore, the methods 200 and 300 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media.

Further, the methods 200 and 300 are described below with reference to the system 102 as described above, other suitable systems for the execution of these methods can be utilized. Additionally, implementation of these methods is not limited to such examples.

Referring to FIG. 2, at block 202, a file having requested data for providing to a user device is identified. In one example, the file is identified for providing requested data in response to a user request received from the user device. Further, the file is stored in a plurality of physical data blocks of a storage device associated with a computing system, for example, the system 102. In one example, upon receiving the user request, analysis module, such as the analysis module 124 of the system 102 analyzes the user request to determine the requested data has to be shared. The file having the requested data is subsequently searched from the storage device.

At block 204, a logical offset range corresponding to the requested data is ascertained. In one example, the system 102 may analyze the file to ascertain the logical offset range corresponding to the requested data. The logical offset range corresponds to a virtual location of the requested data in a file system that is used for organizing information on the storage device of the system 102.

At block 206, a range of physical data blocks in which the requested data is stored is determined, from among the plurality of physical data blocks. In one example, the range of physical data blocks is determined based on a mapping table and a file parameter, such as a file inode and a file name of the file having the requested data that has to be shared. The mapping table includes a mapping between the logical offset range and the requested data. In one example, the system 102 may analyze the logical offset range and the file parameter to determine the range of physical blocks of a storage device of the system 102 in which the requested data is stored.

At block 208, a data block mapping between a snapshot inode and the range of physical data blocks is created for obtaining a partial snapshot of the requested data. In one example, the snapshot inode includes metadata associated with the partial snapshot. The snapshot inode is created based on the determining of the range of physical data blocks.

At block 210, the partial snapshot is rendered to the user device in response to the user request. In one example, once the data block mapping between the snapshot inode and the range of physical data blocks is created, the partial snapshot is created by the system 102.

Referring to FIG. 3, at block 302, a file having requested data that has to be shared with a user device is identified. In one example, the file is identified for providing requested data in response to a user request received from the user device. Further, the file is stored in a plurality of physical data blocks of a storage device associated with a computing system, for example, the system 102. In one example, upon receiving the user request, the system 102 analyzes the user request to determine the requested data has to be shared. The file having the requested data is subsequently searched from the storage device.

At block 304, the file and its file data are copied into a main memory. In one example, the file is obtained from the storage device of the system, say, the system 102 and copied into the main memory. Main memory may be, for example, a RAM of the system 102. Further, in one example, the file maybe copied entirely at once. In another example, parts of the file may be copied sequentially instead of copying the entire file at a once.

At block 306, the file and its file data are analyzed to ascertain a logical offset range corresponding to the requested data. In one example, the system 102 may analyze the file to ascertain the logical offset range corresponding to the requested data. The logical offset range corresponds to a virtual location of the requested data in a file system that is used for organizing information on the storage device of the system 102.

At block 308, a range of physical data blocks in which the requested data is stored is determined. In one example, the range of physical data blocks is determined based on a mapping table and a file parameter, such as a file inode and a file name of the file having the requested data that has to be shared. The mapping table includes a mapping between the logical offset range and the requested data. In one example, the system 102 may analyze the logical offset range and the file parameter to determine the range of physical blocks of the storage device of the system 102 in which the requested data is stored.

At block 310, a snapshot inode referring to the physical data blocks is created. In one example, the snapshot inode is created based on the determining of the range of physical data blocks. For example, the system 102 creates the snapshot inode based on the physical data blocks.

At block 312, a data block mapping is created. In one example, the data block mapping is created between the snapshot inode and the physical data blocks. The data block mapping links the snapshot inode to the physical data blocks for further processing.

At block 314, a partial snapshot of the requested data is generated based on the snapshot inode and the data block mapping. In one example, the system 102 generates the partial snapshot for being rendered to user device in response to the user request.

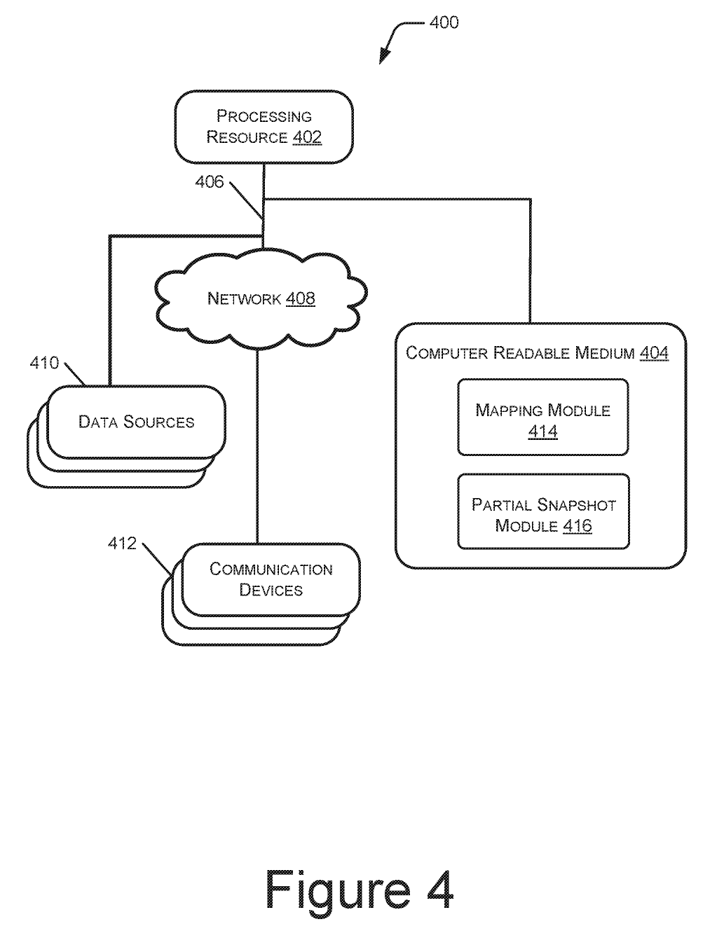

FIG. 4 illustrates a system environment 400 for partial snapshot creation, according to an example of the present disclosure. The system environment 400 may comprise at least a portion of a public networking environment or a private networking environment, or a combination thereof. In one implementation, the system environment 400 includes a processing resource 402 communicatively coupled to a computer readable medium 404 through a communication link 406.

For example, the processing resource 402 can include one or more processors of a computing device for partial snapshot creation. The computer readable medium 404 can be, for example, an internal memory device of the computing device or an external memory device. In one implementation, the communication link 406 may be a direct communication link, such as any memory read/write interface. In another implementation, the communication link 406 may be an indirect communication link, such as a network interface. In such a case, the processing resource 402 can access the computer readable medium 404 through a network 408. The network 408 may be a single network or a combination of multiple networks and may use a variety of different communication protocols.

The processing resource 402 and the computer readable medium 404 may also be coupled to requested data sources 410 through the communication link 406, and/or to communication devices 412 over the network 408. The coupling with the requested data sources 410 enables in receiving the requested data in an offline environment, and the coupling with the communication devices 412 enables in receiving the requested data in an online environment.

In one implementation, the computer readable medium 404 includes a set of computer readable instructions, implementing a mapping module 414 and a partial snapshot module 416. The set of computer readable instructions can be accessed by the processing resource 402 through the communication link 406 and subsequently executed to process requested data communicated with the requested data sources 410 in order to facilitate partial snapshot creation. When executed by processing resource 402, the instructions of mapping module 414 may perform the functionalities described above in relation to mapping module 106. When executed by processing resource 402, the instructions of partial snapshot module 416 may perform the functionalities described above in relation to partial snapshot module 108.

For example, in response to a user request for accessing requested data, the mapping module 414 may identify logical offset range corresponding to the requested data in a file having the requested data. Initially, an analysis module (not shown in the figure) may analyze the user request to determine the requested data that has to be shared with the user device. The analysis module may subsequently perform a search to identify the file having the requested data. In one example, the file is stored in a plurality of physical data blocks of a storage device associated with the communication devices 412.

The mapping module 414 may subsequently analyze the file and its file data to determine logical offset range corresponding to the requested data. The logical offset range corresponds to a virtual location of the requested data in a file system. The mapping module 414 further creates a mapping table having a mapping between the logical offset range and the requested data. The mapping table may be further used by the partial snapshot module 416 to determine a range of physical data blocks of the storage device in which requested data, that has to be shared with the user device, is stored. In one example, the partial snapshot module 416 may determine the range of physical data blocks based on the mapping table and a file parameter, such as a file inode and a file name of the file having the requested data.

The partial snapshot module 416 may further create a snapshot inode referring to the physical data blocks. Further, the partial snapshot module 416 may create a data block mapping between the snapshot inode and the physical data blocks. The partial snapshot module 416 may subsequently generate a partial snapshot for the requested data based on the snapshot inode and the data block mapping for being rendered to the user device. As previously described, creating the partial snapshot facilitates avoiding creation of a copy of the requested data.

Although examples for the present disclosure have been described in language specific to structural features and/or methods, it should stood that the appended claims are not necessarily limited to the specific features or methods described. Rather, the specific features and methods are disclosed and explained as examples of the present disclosure.

I/We claim:

1. A method comprising:
identifying a file having requested data for providing to a user device in response to a user request received from the user device, wherein the file is stored in a plurality of physical data blocks of a storage device;
ascertaining a logical offset range corresponding to the requested data, wherein the logical offset range corresponds to a virtual location of the requested data in a file system;
determining a range of physical data blocks, from among the plurality of physical data blocks, in which the requested data is stored, based on a mapping table and a file parameter, wherein the mapping table includes a mapping between the logical offset range and the requested data;
creating a data block mapping between a snapshot inode and the range of physical data blocks, for obtaining a partial snapshot of the requested data, wherein the snapshot inode includes metadata associated with the partial snapshot; and
rendering the partial snapshot to the user device in response to the user request.

2. The method of claim 1, wherein the identifying further comprises:
analyzing the user request to determine the requested data that has to be shared with the user device; and
performing a search to identify, from among a plurality of files in a storage device, the file having the requested data.

3. The method of claim 1, wherein the ascertaining further comprises:
copying, into a main memory, the file and file data from the storage device; and
analyzing the file and the file data to ascertain the logical offset range.

4. The method of claim 1, further comprising generating the mapping table based on the ascertaining, wherein the mapping table includes a beginning position of the logical offset range and bit length corresponding to the logical offset range.

5. The method of claim 1, wherein the creating further comprising generating the partial snapshot based on the snapshot inode and the data block mapping.

6. The method of claim 1, the creating the data block mapping further comprising creating the snapshot inode based on the determining.

7. A system comprising:
a processor;
a mapping module coupled to the processor to:
ascertain a logical offset range corresponding to requested data that has to be shared with a user device in response to a user request received from the user device, wherein the logical offset range corresponds to a virtual location of the requested data in a file system; and
a partial snapshot module coupled to the processor to:
determine a range of physical data blocks, from among a plurality of physical data blocks, in which the requested data is stored based on a mapping table and a file parameter, wherein the mapping table includes a mapping between the logical offset range and the requested data; and
create a data block mapping between a snapshot inode and the range of physical data blocks to obtain a partial snapshot of the requested data for being rendered to the user device, wherein the snapshot inode includes metadata associated with the partial snapshot.

8. The system as claimed in claim 7, further comprising an analysis module coupled to the processor to:
analyze the user request to determine the requested data that has to be shared with the user device; and
perform a search to identify a file having the requested data, wherein the file is stored in the plurality of physical data blocks of a storage device associated with the system.

9. The system as claimed in claim 8, wherein the analysis module further is to copy, into a main memory of the system, the file and file data from the storage device.

10. The system as claimed in claim 9, wherein the mapping module further is to:
analyze the file and file data to ascertain the logical offset range; and
generate the mapping table based on the logical offset range, wherein the mapping table includes a beginning position of the logical offset range and bit length corresponding to the logical offset range.

11. The system as claimed in claim 7, wherein the partial snapshot module further is to:
generate the partial snapshot based on the snapshot inode and the data block mapping for being rendered to the user device.

12. A non-transitory computer readable medium having a set of computer readable instructions that, when executed, cause a processor to:
determine, based on a mapping table and a file parameter, a range of physical data blocks of a storage device in which requested data, that has to be shared with a user device, is stored, wherein the mapping table includes a mapping between a logical offset range and the requested data, and wherein the logical offset range corresponds to a virtual location of the requested data in a file system;
create a snapshot inode referring to the physical data blocks, based on the determining;
create a data block mapping between the snapshot inode and the physical data blocks; and
generate a partial snapshot based on the snapshot inode and the data block mapping for being rendered to the user device.

13. The non-transitory computer readable medium of claim 12, wherein the computer readable instructions, when executed, further cause the processor to:
receive a user request from the user device;
analyze the user request to determine the requested data that has to be shared with the user device; and
perform a search to identify a file having the requested data, wherein the file is stored in a plurality of physical data blocks of the storage device.

14. The non-transitory computer readable medium of claim 13, wherein the computer readable instructions, when executed, further cause the processor to:
copy, into a main memory of the system, the file and file data from the storage device; and
analyze the file and the file data to ascertain the logical offset range corresponding to the requested data.

15. The non-transitory computer readable medium of claim 12, wherein the computer readable instructions, when executed, further cause the processor to generate the mapping table based on the logical offset range, wherein the mapping table includes a beginning position of the logical offset range and bit length corresponding to the logical offset range.
